(19) United States
(12) Patent Application Publication
(10) Pub. No.: US 2004/0054104 A1
(43) Pub. Date: Mar. 18, 2004

(54) Coatings for drug delivery devices comprising modified poly(ethylene-co-vinyl alcohol)

(76) Inventor: Stephen D. Pacetti, San Jose, CA (US)

Correspondence Address: Cameron Kerrigan, Squire, Sanders & Dempsey L.L.P., One Maritime Plaza, Suite 300, San Francisco, CA, 94111, US

(21) Appl. No.: 10/236,366

(22) Filed: Sep. 5, 2002

(51) Int. Cl. C08F 12/20

(52) U.S. Cl. 526/242; 526/286; 526/317.1; 526/279

(57) ABSTRACT

A polymer coating for medical devices based on a derivatized poly(ethylene-co-vinyl alcohol) is disclosed. A variety of polymers are described to make coatings for medical devices, particularly, for drug delivery stents. The polymers include poly(ethylene-co-vinyl alcohol) modified by alkylation, esterification, and introduction of fluorinated alkyl fragments, polysiloxane fragments and poly(ethylene glycol) fragments into the macromolecular chains of poly(ethylene-co-vinyl alcohol).

### BACKGROUND OF THE INVENTION

1. Field of the Invention

This invention relates to the field of medical devices, especially devices used for delivery of drugs. More particularly, it is directed to coatings for drug delivery devices, such as drug eluting vascular stents.

2. Description of the State of the Art

A stent is a tubular scaffolding structure used to mechanically uphold the patency of the lumen in which the stent is placed. Stents are being modified to also provide biological therapy. One method of medicating a stent is with the use of a polymer coating impregnated with a drug. A variety of polymers can be used to coat stents. Of particular interest is a copolymer of ethylene and vinyl alcohol, also known as poly(ethylene-co-vinyl alcohol) having a general formula —[CH₂—CH₂]ₘ—[CH₂—CH(OH)]ₙ—. Poly(ethylene-co-vinyl alcohol) is also known under the trade name EVAL and is distributed commercially by Aldrich Chemical Company of Milwaukee, Wis. EVAL is also manufactured by EVAL Company of America of Lisle, Ill.

EVAL is a product of hydrolysis of ethylene-vinyl acetate copolymers. Those having ordinary skill in the art of polymer chemistry will understand that EVAL may also be a terpolymer and may include up to 5% (molar) of units derived from styrene, propylene and other suitable unsaturated monomers. EVAL possesses a desirable impermeability to oxygen, is bio- and blood-compatible, and adheres well to metal, such as stainless steel. EVAL contains a high concentration of hydroxyl groups from the vinyl alcohol component of the macromolecule. These hydroxyl groups are hydrophilic and lead to some swelling of the polymer when immersed in water. This effect is somewhat mitigated by two factors. One is strong interchain hydrogen bonding between hydroxyl groups, and the other is the hydrophobic ethylene component of the macromolecule.

While EVAL has been shown to be a very inert and biocompatible polymer which is quite suitable for use with implantable medical devices, some of its properties can be improved. In particular, the hydrogen bonding mentioned above makes the polymer difficult to dissolve in an organic solvent. This necessitates the use of very polar solvents, such as dimethylacetamide (DMAC) or dimethylsulfoxide (DMSO). Such solvents have high boiling points and are difficult to remove. Facile removal of solvents during coating processes is advantageous as it leads to fewer coating defects, such as webbing, and allows for quicker manufacturing process.

At the same time, the same hydroxyl groups that cause the hydrogen bonding are also responsible for insufficient water resistance, and in many applications EVAL does absorb more water than desired. In fact, the commonly used grade of EVAL with n=56 (concentration of vinyl units about 56 mole %) can absorb 5 mass % of water.

Although EVAL has a high degree of crystallinity, its ability to control the release of drugs has limitations. An inability to control the release rate of drugs below a certain size or molecular weight stems from its water adsorption which is in turn caused by an insufficient degree of hydrophobicity. The presence of a substantial amount of hydroxyl groups leads to a level of water adsorption that causes the polymer to swell, increasing the polymer's porosity, and drug diffusivity.

An improvement over EVAL is desired, so that the polymer forming the stent coating has a higher degree of hydrophobicity and a lower degree of crystallinity as compared to conventional EVAL coatings.

In view of the foregoing, it is very desirable to have alternative polymeric materials suitable for the use with various medical devices, particularly, with stents for controlled drug delivery. These polymeric materials should be bio- and blood-compatible, at least partially impermeable to oxygen, melt-processable, have reduced crystallinity, high hydrophobicity, high tensile strength and flexibility, ability to provide slower drug release rates, and be soluble in organic solvents.

The present invention provides a number of such polymers according to the following description.

### SUMMARY

According to one embodiment of this invention, a coating for medical devices is provided, the coating comprises a polymer having a formula

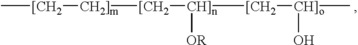

wherein R is selected from a group consisting of a straight chained or branched alkyl radical C₁-C₈, a fully or partially fluorinated alkyl sulfonyl group C₁-C₈, a fully or partially fluorinated alkyl group C₁-C₈, an acyl group, a secondary amino group, and a substitutent derived from a macromolecular compound.

According to yet another embodiment of the present invention, a method for fabricating a polymer coating for a medical device is provided, the method comprises modifying poly(ethylene-co-vinyl alcohol). The modifying can be achieved by alkylation, fluoroalkylation, silicone addition, esterification, pegylation, introduction of amino groups, and introduction of carboxyl group.

According to yet another embodiment of the present invention, a method coating a medical device is provided, the method includes forming a coating comprising a polymer on the device, wherein the polymer has a formula

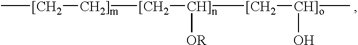

wherein R is selected from a group consisting of a straight chained or branched alkyl radical C₁-C₈, a fully or partially fluorinated alkyl C₁-C₈ sulfonyl group, a fully or partially fluorinated alkyl group C₁-C₈, an acyl group, a secondary amino group, and a substitutent derived from a macromolecular compound.

### DETAILED DESCRIPTION

According to the present invention, polymers used to make coatings for medical devices, in particular, for drug delivery stents, are derivatives of EVAL. The derivatization or modification of EVAL is accomplished by either reactions of polymer-analogous transformation of EVAL or by co-polymerization. The derivatized EVAL remains chemically stable and highly biologically compatible.

The embodiments of this invention disclose a number of polymer-derivatives of EVAL to be used as coatings with medical devices, particularly, with stents for controlled local delivery of drugs. The polymers used in the embodiments of this invention can be divided into two categories. The first category includes polymers which are products of hydrophobic modification of EVAL. The polymers in this category include the products of alkylation of EVAL, the products of fluoroalkylation of EVAL (when fluorinated hydrocarbon chains are added to the macromolecule of EVAL), and the products of adding polysiloxane fragments to EVAL's chains. Also in this category are the EVAL derivatives obtained by introduction of ester fragments into EVAL's macromolecules.

As a result of hydrophobic modification, the polymers in this category can possess a higher degree of hydrophobicity and lower degree of crystallinity as compared to conventional EVAL coatings. The modified coating has a lower degree of water swelling and allows for slower drug release rates than what is possible with conventional EVAL. The water absorption of the hydrophobically modified EVAL of the present invention can be less than 5% (by mass).

The polymers in this category can also be more readily dissolved in organic solvents because the polymer has less hydrogen bonding.

The second category includes products of hydrophilic modification of EVAL, for example, modification by poly(ethylene glycol) (“pegylation”), or by introduction of amino or carboxyl groups to the EVAL's chain. As a result of modification by poly(ethylene glycol), the biological compatibility of EVAL can be improved.

For derivatization by the reactions of polymer-analogous transformation, EVAL with concentration of about 56 molar % of vinyl units (corresponding to about 67 mass %) can be typically used. Other brands of EVAL can be selected according to the criteria chosen by those having ordinary skill in the art. The degree of functionalization of EVAL need not be high. Functionalization of between about 5% and about 25%, for example, about 10% of the vinyl-alcohol-derived units of EVAL can be sufficient.

A polymer of this invention can be used as a coating on a medical device, particularly, on a drug delivery stent. The coating can be applied onto the stent by a commonly used method known to one of ordinary skill in the art, for instance, by spraying, dipping or molding. The drug can be incorporated within the coating, the drug can be in a separate layer underneath the coating, or the drug can be adsorbed onto the surface of the coating. The coating can also be used as a primer layer or a topcoat layer.

The stent, or other implantable medical device can be used in any part of the vascular system, including neurological, carotid, coronary, renal, aortic, iliac, femoral or any other part of the peripheral vasculature. The are no limitations on the size of the stent, its length, diameter, strut thickness or pattern. Examples of such implantable devices include self-expandable stents, balloon-expandable stents, stent-grafts, grafts (e.g., aortic grafts). The coating can also be used with artificial heart valves, cerebrospinal fluid shunts, coronary shunts, pacemaker electrodes, and endocardial leads (e.g., FINELINE and ENDOTAK, available from Guidant Corporation). The underlying structure of the device can be of virtually any design. The device can be made of a metallic material or an alloy such as, but not limited to, cobalt chromium alloy (ELGILOY), stainless steel (316L), “MP35N,” “MP20N,” ELASTINITE (Nitinol), tantalum, nickel-titanium alloy, platinum-iridium alloy, gold, magnesium, or combinations thereof. “MP35N” and “MP20N” are trade names for alloys of cobalt, nickel, chromium and molybdenum available from standard Press Steel Co., Jenkintown, Pa. “MP35N” consists of 35% cobalt, 35% nickel, 20% chromium, and 10% molybdenum. “MP20N” consists of 50% cobalt, 20% nickel, 20% chromium, and 10% molybdenum. Devices made from bioabsorbable or biostable polymers could also be used with the embodiments of the present invention.

The therapeutic substance of drug can include any substance capable of exerting a therapeutic or prophylactic effect in the practice of the present invention. The drug may include small molecule drugs, peptides or proteins. The drug can be for inhibiting abnormal or inappropriate migration and proliferation of smooth muscular cells for the treatment of restenosis.

Examples of the drugs which are usable include antiproliferative substances such as actinomycin D, or derivatives and analogs thereof. Synonyms of actinomycin D include dactinomycin, actinomycin IV, actinomycin I₁, actinomycin X₁, and actinomycin C₁. The active agent can also fall under the genus of antineoplastic, anti-inflammatory, antiplatelet, anticoagulant, antifibrin, antithrombin, antimitotic, antibiotic, antiallergic and antioxidant substances. Examples of antineoplastics and/or antimitotics include paclitaxel, docetaxel, methotrexate, azathioprine, vincristine, vinblastine, fluorouracil, doxorubicin hydrochloride, and mitomycin. Examples of antiplatelets, anticoagulants, antifibrin, and antithrombins include sodium heparin, low molecular weight heparins, heparinoids, heparin derivatives containing hydrophobic counter-ions, hirudin, argatroban, forskolin, analogues, vapiprost, prostacyclin and prostacyclin dextran, D-phe-pro-arg-chloromethylketone (synthetic antithrombin), dipyridamole, glycoprotein IIb/IIIa platelet membrane receptor antagonist antibody, recombinant hirudin, and thrombin. Examples of cytostatic or antiproliferative agents include angiopeptin, angiotensin converting enzyme inhibitors such as captopril, cilazapril or lisinopril, calcium channel blockers (such as nifedipine), colchicine, fibroblast growth factor (FGF) antagonists, fish oil (ω-3-fatty acid), histamine antagonists, lovastatin (an inhibitor of HMG-CoA reductase, a cholesterol lowering drug), monoclonal antibodies (such as those specific for Platelet-Derived Growth Factor (PDGF) receptors), nitroprusside, phosphodiesterase inhibitors, prostaglandin inhibitors, suramin, serotonin blockers, steroids, thioprotease inhibitors, triazolopyrimidine (a PDGF antagonist), and nitric oxide. An example of an antiallergic agent is permirolast potassium. Other therapeutic substances or agents which may be appropriate include alpha-interferon, genetically engineered epithelial cells, tacrolimus, clobetasol, dexamethasone and its derivatives, and rapamycin, its derivatives and analogs, such as 40-O-(2-hydroxy)ethyl-rapamycin (known by the trade name of EVEROLIMUS available from Novartis Corp. of New York), 40-O-(3-hydroxy)propyl-rapamycin, 40-O-[2-(2-hydroxy)ethoxy]ethyl-rapamycin, and 40-O-tetrazole-rapamycin.

The following examples demonstrate the processes used to derivatize EVAL to make coatings for medical devices.

A. Hydrophobic Modification of Eval

### EXAMPLE 1

### Modification by Alkylation (Polymer-Analogous Transformation)

Alkylation reduces the interchain hydrogen bonding improving the solubility of the polymer in organic solvents which will solvate the added aliphatic functionality. Most straightforward alkylation process is directed to the O—H bonds of EVAL and produces chemically stable C—O—R ether linkages as shown by reaction scheme (I):

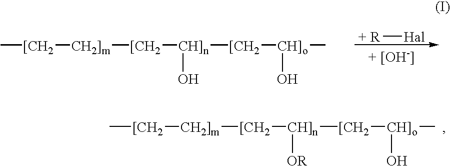

where R is a C₁-C₈ alkyl, for example, methyl, ethyl, a propyl or a butyl, and Hal is a halogen, for example, chlorine, bromine, or iodine. Integers “m,” “n,” and “o” signify molar amounts of the respective fragments of the macromolecular chain of EVAL. A brand of EVAL can be used where m=44 molar % and n+o=56 molar %. This brand of EVAL can have an average molecular weight within a range between about 60,000 and about 90,000 Daltons. For this range of the molecular weight, the value of “m” can vary from about 700 and about 1,100 and the value of (“n”+“o”) from about 900 and 1,400. For such values of “m,” “n,” and “o,” the brand of EVAL is composed of about 66.7 mass % of the vinyl alcohol-derived fragments and about 33.3 mass % of the ethylene-derived fragments.

The value of the integer “n” signifies the amount of modified vinyl alcohol-derived fragments. Between about 5 and 25%, for example, about 10% of vinyl alcohol-derived fragments can be modified, corresponding to the ratio of “n” to “o” of between about 1:19 and about 1:3, for instance, about 1:9.

About 3 liters of 10% (by weight) solution of EVAL in an appropriate organic solvent can be used to conduct the reaction (I), typically yielding about 250 grams of alkylated EVAL.

Instead of alkyl halides R-Hal, EVAL can be alkylated by alkylsulfates, yielding the same final ether. Thus, methyl iodide (CH₃I), or dimethylsulfate((CH₃)₂SO₄) can be, for instance, used to obtain a methyl ether derivative of EVAL. As another alternative, to obtain the methyl ether derivative, EVAL can be alkylated using diazomethane CH₂N₂ in the presence of an acid catalyst such as HBF₄ or BF₃ as shown by reaction (Ia):

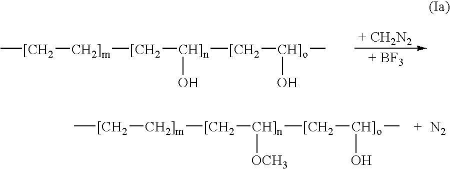

Reactions (I) and (Ia) generally will occur only very slowly because EVAL, as other alcohols, exhibits properties of neither a strong base nor of a strong acid. Consequently, the rate of conversion of the alcohol fragments into the ether fragments will be low.

The process of the formation of the ether bonds can be accelerated if reaction (I) is carried according to a method known as the Williamson synthesis. In the Williamson synthesis, some of the EVAL's hydroxyl groups are first converted into alkoxy-anions having the formula —-[CH₂—CH₂]ₘ—[CH₂—CH(O⁻)]ₙ—[CH₂—CH(OH)]ₒ—, (II), by reacting EVAL with an appropriate reagent such as potassium t-butoxide, sodium amide (NaNH₂), sodium hydride (NaH), sodium methoxide, potassium methoxide, or an alkali metal, for example, sodium.

Alkoxy-anion (II) is a strong nucleophilic substance which readily enters an S_{N}2 reaction of nucleophilic substitution to yield the etherized EVAL shown as the final product of reaction (I).

It should be kept in mind that the S_{N}2 reaction competes in the Williamson synthesis with the E₂ reaction of elimination. The risk exists of the occurrence of the undesirable event when the final product of the reaction of alkylation according to Williamson will lead to a mixture of unsaturated moieties (the products of the E₂ reaction) with ethers. In an extreme case, the E₂ reactions may prevail over the S_{N}2 reactions to yield only the unsaturated moieties instead of the ethers.

This risk is pronounced in case of EVAL where the alkoxy-anion (II) is a bulky structure creating steric hindrances to the S_{N}2 reactions. Therefore, it is important to create conditions (temperature, choice of the R-Hal alkylating agent, etc.) favoring the S_{N}2 reaction over the E₂ reaction. Those having ordinary skill in the art will select the conditions most propitious to reaction (I) and the formation of the ethers.

Alternatively, EVAL can be alkylated by an olefin in the presence of an acid. In sum, such reaction can be shown as follows:

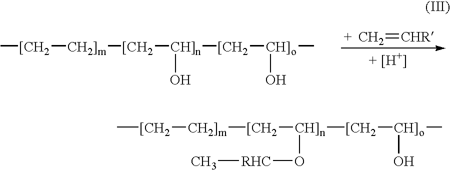

where R′ is a C₁-C₈ alkyl, for example, methyl, ethyl, a propyl, or a butyl.

Reaction (III) is expected to occur according to the Markovnikoff rule and the hydroxyl group's proton leaving EVAL joins the most hydrogenized carbon in the vinyl structure CH₂═CH— of the olefin CH₂═CHR′. This will yield an ether structure as the product of reaction (III).

If desired, those having ordinary skill in the art can change the addition shown by reaction (III) to the anti-Markovnikoff addition. For example, if the reaction is carried in the presence of peroxides, the reaction will follow the Karasch-Mayo path and hydroxyl group's proton leaving EVAL will join the secondary carbon in the vinyl structure to yield the product (IV):

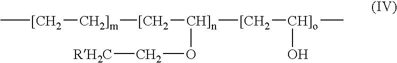

Those having ordinary skill in the art will determine whether the product of reaction (III) or reaction (IV) is better suited to a particular application and will select the conditions of the reaction of addition (temperature, solvent, the presence or absence of peroxide, the choice of R′, etc.) accordingly.

Other alternative methods of alkylation of EVAL that can be used include reaction of EVAL with oxonium ions from onium salts and reductive alkylation of EVAL. Those having ordinary skill in the art will choose most appropriate synthetic paths and conditions if the alkylation is desired to be carried according to these alternative methods. For example, if the method of reductive alkylation is selected, EVAL can be reacted with acetaldehyde, trifluoro acetic acid and triethylsilane to form the intermediate hemiacetal, which is then reduced to form the ethyl ether derivative of EVAL.

The EVAL derivatives produced as a result of reactions (I), (Ia), (III), (IV) or by other alternative methods will possess a higher degree of hydrophobicity and lower degree of crystallinity as compared to conventional EVAL coatings and can be used to fabricate coatings for the implantable medical devices such as stents.

### EXAMPLE 2

### Modified EVAL by Copolymerization

The modified EVAL shown as the product of reactions (I), (Ia), (III), or (IV) is a terpolymer which can be synthesized by copolymerization of ethylene, vinyl acetate and a suitable vinyl ether, followed by the catalytic base hydrolysis of the acetate moieties. The vinyl ether-derived fragments of the copolymer will survive the process of saponification because the acetate groups are substantially more labile and susceptible to hydrolysis.

The process of co-polymerization usually involves a free radical co-polymerization, but any other otherwise acceptable method of co-polymerization known to those skilled in the art can be used as well. Those having ordinary skill in the art will also select the most appropriate conditions for the co-polymerization and for the saponification.

### EXAMPLE 3

### Modification by Fluoroalkylation (Polymer-Analogous Transformation)

Introduction of fluorocarbon groups —CF₂— into EVAL can provide EVAL with the properties usually associated with TEFLON and similar fluorinated polymers. In particular, the derivatized EVAL can be more hydrophobic, more inert and highly blood compatible.

The modification of EVAL can be carried out according to the following functionalization scheme:

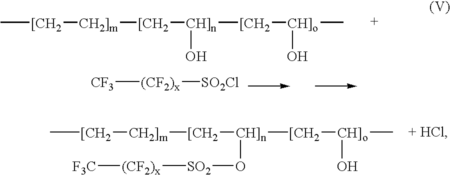

where “x” is an integer having a value between 0 and 7, for example between 0 and 3. Integers “m,” “n,” and “o” are the same as in Example 1. Instead of perfluorinated alkylsulfonyl chloride CF₃—(CF₂)ₓ—SO₂Cl, a partially fluorinated alkyl sulfonyl chloride CHₐF_{b}—(CH_{c}F_{d})ₓ—SO₂Cl (VI) can be alternatively used in which case the modified EVAL will include partially fluorinated alkyl sulfonyl substitutent instead of the perfluorinated substitutent shown by reaction (V). In such partially fluorinated alkyl sulfonyl substitutent shown by formula (VI), a+b=3, where a=0, 1, 2 or 3, and c+d=2, where c=0, 1 or 2, and wherein if a=0, then c≠0, and if c=0, then a≠0.

Fluorinated alkylsulfonyl chloride is a strong Lewis acid which readily participates in the substitution reaction (V). If necessary, EVAL can be preliminarily activated according to the Williamson synthesis to form alkoxy-anions (II), as shown in Example 1. If such path is followed, the perfluorinated or partially fluorinated sulfonyl chloride will be the alkylating agent used instead of an alkyl halide shown by reaction (I).

It should be borne in mind that the reaction (V) gets more difficult to carry when the integer “x” is increased, due to interference from inevitable steric hindrances. Those having ordinary skill in the art will select proper conditions under which reaction (V) is carried out.

In addition, as the contents of fluorine in the derivatized EVAL increase, the polymer's hydrophobicity, inertness and hemocompatibility increase, but the adhesion of the functionalized polymer to stainless steel and other substrates decreases. The proper balance between these competing properties can be selected by those having ordinary skill in the art.

If the degree of functionalization is relatively high, the adhesion can become poor and the polymer can be used mostly as a outermost layer of the stent coating.

### EXAMPLE 4

### Fluoroalkylated EVAL Obtained by Co-Polymerization

The modified EVAL shown as the product of reaction (V) (less the sulfonyl bridge) is a terpolymer which can be synthesized by copolymerization of ethylene, vinyl acetate and a suitable fluorinated vinyl ether, followed by the alcohol catalytic base hydrolysis of the acetate moieties.

As in Example 2, the fluorinated vinyl ether-derived moieties will survive the saponification, while the acetate moieties are going to be hydrolyzed. The modified EVAL can have a structure as shown by formula (VII):

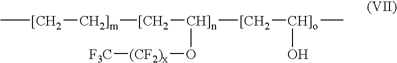

The most appropriate conditions for the copolymerization and for the saponification, as well as the particular value for “x” are to be selected by those having ordinary skill in the art. The value of “x” can be between 0 and 7, for example, between 0 and 3. By analogy with Example 3, a partially fluorinated product can be obtained if a partially fluorinated vinyl ether is used for copolymerization. In this case, the resulting polymer (VII) will include partially fluorinated alkyl group instead of the perfluorinated alkyl shown by formula (VII).

### EXAMPLE 5

### Modification by Silicone Addition (Polymer-Analogous Transformation)

EVAL can be modified by low molecular weight oligomers based on poly(dimethylsiloxane)(PDMS), thus introducing silicone fragments into EVAL's macromolecules. Such functionalization will provide EVAL with improved hydrophobicity, improved surface inertness as well as excellent blood compatibility.

A good way to modify EVAL with a PDMS-based oligomer is to react EVAL with epoxy-terminated low molecular weight PDMS available from United Chemical Technologies, Inc. of Bristol, Pa. Such oligomer is a PDMS-based product having epoxy fragments. An example of a suitable PDMS— based oligomer is a mono-epoxy terminate product having a molecular weight in the range of between about 300 and about 3,000 Daltons with a general formula

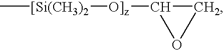

wherein “z” is an integer between 4 and 40.

Epoxy groups in the PDMS-based oligomer can be made to react with the hydroxyl groups of EVAL. Typically, the epoxy group reacts with nucleophilic hydroxyl group of EVAL, via the nucleophilic substitution reaction S_{N}2. Normally, the proton of the hydroxyl group attacks the less substituted a-carbon atom of the oxirane ring of the epoxy group. The other, β-carbon is less accessible due to the steric hindrances. As the result of the proton attack on the α-carbon atom, the ring opens and the modified EVAL is formed according to reaction (VIII):

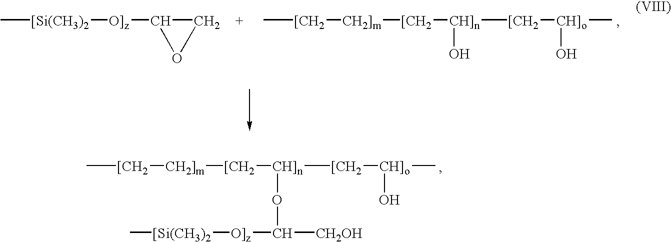

Reaction (VIII) is carried out smoother in the presence of the electron acceptors, because the electron acceptors facilitate electrophilic polarization of the C—O bond of the epoxy ring, thus making the subsequent nucleophilic attack by the proton of the hydroxyl group of EVAL easier.

Accordingly, modification of EVAL with the mono-epoxy terminated PDMS is facilitated in the presence of ring-opening catalysts, for instance, a Lewis base. Lewis acids or aprotonic acids such as boron trifluoride can be also used as the ring-opening agents.

The conditions under which reaction (VIII) is conducted will be determined by those having ordinary skill in the art. As the contents of silicone in the derivatized EVAL increase, the adhesion of the functionalized polymer to stainless steel and other substrates decreases. If the degree of functionalization is relatively high, the adhesion becomes poor and the polymer will be used only as a outermost layer of the stent coating. For example, the polymer can be used as a topcoat layer over a drug layer or a drug layer disposed over a primer layer.

### EXAMPLE 6

### Modification by Esterification (Polymer-Analogous Transformation)

EVAL can be modified by introducing ester fragments into EVAL's macromolecules. Such modification is defined as “esterification.” EVAL modified by esterification can exhibit improved solubility, lower glass transition temperature, and good biocompatibility, while preserving good adhesion, good flexibility and other positive coating properties characterizing original, unmodified EVAL.

The process of esterification takes place in a solution, for example, in DMAC, in the presence of a tertiary amine. The agent used to esterify EVAL can be a C₂-C₉ organic acid Z-COOH, such as acetic acid (Z=CH₃), propionic acid (Z=C₂H₅), butyric acid (Z=C₃H₇), valeric acid (Z=C₄H₉), caproic acid (Z=C₅H₁₁), enanthic acid (Z=C₆H₁₃), caprylic acid (Z=C₇H₁₅), or pelargonic acid (Z=C₈H₁₇). Each of propionic acid, butyric acid, valeric acid, caproic acid, enanthic acid, caprylic acid, or pelargonic acid can be straight-chained or branched. Derivatives of the above-listed acids, such as corresponding acyls or anhydrides can be used for esterification instead of the acids, if desired.

One example of the process of esterification of EVAL according to this invention is the process of making the butyl ester of EVAL. For the purposes of the present invention this process is defined as “butylation.” To carry the butylation of EVAL, an acyl derivative of pentanoic acid, for example, valeryl chloride or isovaleryl chloride, can be employed. A typical reaction of butylation can be schematically illustrated as reaction (IX):

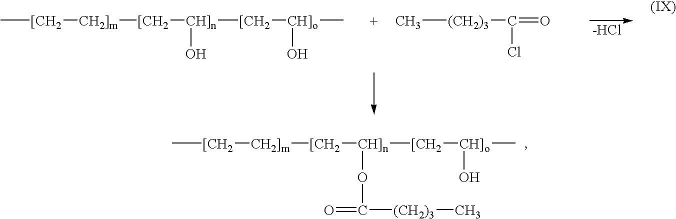

where integers “m,” “n,” and “o” are the same as in Example 1.

The final polyester product of reaction (IX) can be precipitated from the DMAC solution using water. The butylated EVAL derivative produced as a result of reaction (IX) will possess a higher degree of hydrophobicity and lower degree of crystallinity as compared to EVAL and can be used to fabricate coatings for the implantable medical devices.

B. Hydrophilic Modification of Eval

### EXAMPLE 7

### Modification with Poly(Ethylene Glycol)

EVAL can be modified by reacting with poly(ethylene glycol). For the purposes of the present invention such process of modification is defined as “pegylation.”

Poly(ethylene glycol) (PEG) having a general formula HO-[CH₂CH₂—O]ₙ—H is a highly biologically compatible product. Due to the presence of hydroxyl groups, it is capable of entering reactions of condensation with EVAL shown schematically by the pegylation reaction (X):

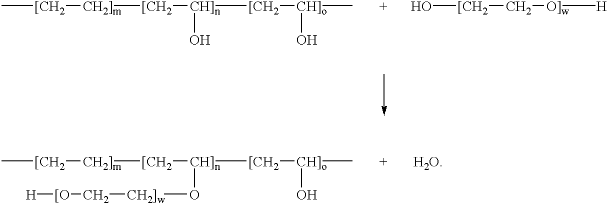

The pegylation reaction (X) may need to be catalyzed by a suitable acidic or basic catalyst. Such catalyst can be selected, if needed, by those having ordinary skill in the art. PEG can be in an oligomeric or polymeric form and can have a molecular weight within a range of between about 500 and about 30,000 Daltons. The conditions under which this reaction is conducted can be determined by those having ordinary skill in the art.

If a direct reaction (X) is too slow or the yield is insufficient, PEG can be alternatively covalently coupled to the EVAL backbone by a two-step technique using a succinimidyl reagent. Such technique is known to those having ordinary skill in the art.

Yet another alternative method of pegylation can be a direct addition of ethylene oxide to EVAL by anionic polymerization of ethylene oxide on an EVAL backbone. As a result, EVAL is firmly bonded to the biologically compatible PEG.

PEG covalently linked to the EVAL chain by any of the above methods will not leach out of the polymer and will provide long lasting non-fouling and protein repellant properties.

### EXAMPLE 8

### Modification with Poly(ethylene glycol)-amine Adduct (Polymer-Analogous Transformation)

Poly(ethylene glycol)-amine adduct is a PEG-based product having amino groups NH₂. An example of a PEG-based amino adduct suitable as a modifier for EVAL is a methoxylated product having a general formula CH₃—[O—CH₂—CH₂]_{q}—NH₂. This adduct, manufactured by Shearwater Corp. of Huntsville, Ala., has a molecular weight of about 5,000 which corresponds to the value of the integer “q” of about 113.

Modification of EVAL with a PEG-amine adduct is a two-step process. First, PEG is activated, for example, by tosylation or tresylation. Tosyl chloride is a derivative of toluene, para-toluenesulfonyl chloride having the formula CH₃—C₆H₄—SO₂Cl.

EVAL is tosylated according to reaction (XI) and tosyl group is attached to the EVAL backbone via hydroxy group to yield the toluenesulfoester:

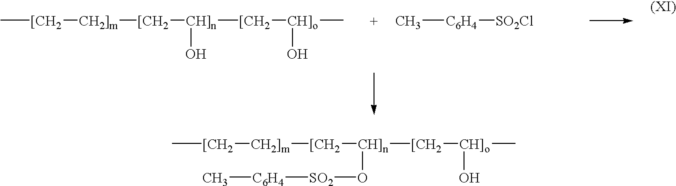

Alternatively, tresyl chloride (2,2,2-trifluoro-ethanesulphonyl chloride) can be used to derivatize EVAL, according to reaction scheme (XII) and tresyl group is attached to the EVAL backbone via hydroxy group:

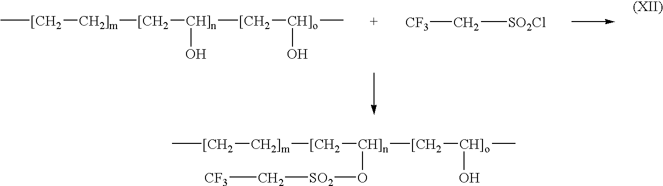

Due to the presence of the amino groups, PEG-amine adduct is chemically quite active and can be alkylated with the tosylated or tresylated EVAL in solution. Typically, compared with the hydroxyl group of EVAL, the amino group is more reactive towards alkylating agents such as tosylated or tresylated agents.

In addition, since toluenesulfonic acid is known to be a very strong acid, on par with sulfuric or hydrochloric acids, its anion, CH₃—C₆H₄—SO₃—, is an excellent leaving group in the nucleophilic substitution alkylation reaction of a primary amine, much better than hydroxyl group of underivatized EVAL.

Accordingly, in the second step of the process of modification of EVAL with the PEG-amine adduct, the tosylated EVAL obtained as described above, reacts with PEG-amine adduct as schematically shown by the alkylation reaction (XIII):

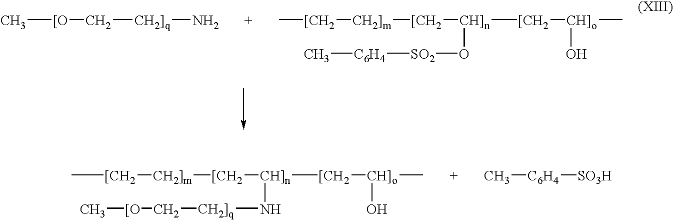

The conditions under which this reaction is conducted can be determined by those having ordinary skill in the art. The reaction of tresylated EVAL and PEG-NH₂ is similar to reaction (XIII). As a result, EVAL can be firmly bonded to the biologically compatible PEG-amino adduct to form the secondary amine product of reaction (XIII). Thus, EVAL is modified by the PEG amino adduct and the modified EVAL has enhanced long-term biocompatibility.

A secondary amino group attached to PEG can be alternatively introduced to the EVAL chain by a two-step technique using an aliphatic diisocyanate. Such technique is known to those having ordinary skill in the art.

### EXAMPLE 9

### Fabrication of the Coating

The polymer of Example 1 is dissolved in a mixture of solvents comprising 50% DMSO and 50% DMAC (by weight) to form a 2% solution. All percentage amounts are by weight. A spray apparatus, such as an EFD 780S spray nozzle with a VALVEMATE 7040 control system, manufactured by EFD, Inc. of East Providence, R.I. is used to apply the polymer solution to a stent. The EFD 780S spray nozzle is an air-assisted external mixing atomizer. The composition is atomized by air and applied to the stent surfaces. During the process of applying the composition, the stent can be optionally rotated about its longitudinal axis, at a speed of 50 to about 150 rpm. The stent can also be linearly moved along the same axis during the application.

The 2% solution of the polymer is applied to a 13-mm TETRA stent (available from Guidant Corporation) in a series of 10-second passes, to deposit 10 μg of coating per spray pass. Between the spray passes, the stent is dried for 10 seconds using flowing air with a temperature of 80° C. Five spray passes are applied to form a 50 μg primer layer, followed by baking the primer layer at 140° C. for one hour.

A drug containing formulation is prepared comprising 2% of the polymer, 1.33% of a derivative of rapamycin and 96.67% of a mixture of solvents comprising 50% DMSO and 50% DMAC. In a manner identical to the application of the primer layer, seventy spray passes are performed to form a 700 μg drug-polymer layer, followed by baking the drug-polymer layer at 50° C. for 2 hours.

Next, a topcoat composition to control the drug release rate is prepared, comprising 2% of the polymer and 98% of a mixture of solvents comprising 80% DMAC and 20% pentane. In a manner identical to the application of the primer layer and the drug-polymer layer, fifteen spray passes are performed to form a 150 μg topcoat layer, followed by final baking at 50° C. for 2 hours.

Finally, a finishing composition is prepared, comprising 2% of the polymer and 98% of a mixture of solvents comprising 50% DMAC, 20% DMSO and 30% ethanol. In a manner identical to the application of the primer layer and the drug-polymer layer, thirty-five spray passes are performed to form a 350 μg finishing coat layer, followed by final baking at 50° C. for 2 hours. Stent coating can be prepared in a similar fashion using other polymers described above.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention. Claims

What is claimed is:

1. A coating for a medical device, the coating comprising a polymer having a formula: 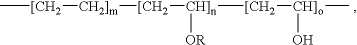
wherein R is selected from a group consisting of a straight chained or branched alkyl radical C₁-C₈, a fully or partially fluorinated alkyl C₁-C₈ sulfonyl group, a fully or partially fluorinated alkyl group C₁-C₈, an acyl group, a secondary amino group, and a substitutent derived from a macromolecular compound.

2. The coating of claim 1, wherein the alkyl radical is selected from a group consisting of methyl, ethyl, n-propyl, iso-propyl, n-butyl, iso-butyl, and tert-butyl.

3. The coating of claim 1, wherein in the fluorinated alkyl sulfonyl group, the alkyl is selected from a group consisting of methyl, ethyl, n-propyl, iso-propyl, n-butyl, iso-butyl, and tert-butyl.

4. The coating of claim 1, wherein the fluorinated alkyl sulfonyl group is selected from a group of substitutents having formulae CF₃—(CF₂)ₓ—SO₂— and CHₐF_{b}—(CH_{c}F_{d})ₓ—SO₂— wherein:
“x” is an integer having a value between 0 and 3;
“a” is an integer having value of 0, 1, 2 or 3;
“b” is an integer;
“c” is an integer having value of 0, 1 or 2;
“d” is an integer; and wherein:
“a”+“b”=3 and “c”+“d”=2; where if “a”=0, then “c”≠0, and if ¢c∞=0, then “a”≠0.

5. The coating of claim 1, wherein in the fluorinated alkyl group, the alkyl is selected from a group consisting of methyl, ethyl, n-propyl, iso-propyl, n-butyl, iso-butyl, and tert-butyl.

6. The coating of claim 1, wherein the fluorinated alkyl group is selected from a group of substitutents having formulae CF₃—(CF₂)ₓ— and CHₐF_{b}—(CH_{c}F_{d})ₓ—, wherein:
“x” is an integer having a value between 0 and 3;
“a” is an integer having value of 0, 1, 2 or 3;
“b” is an integer;
“c” is an integer having value of 0, 1 or 2;
“d” is an integer; and wherein:
“a”+“b”=3 and “c”+“d”=2; where if “a”=0, then “c”≠0, and if “c”=0, then “a”≠0.

7. The coating of claim 1, wherein the acyl group is derived from an acid selected from a group consisting of acetic acid, propionic acid, butyric acid, valeric acid, caproic acid, enanthic acid, caprylic acid, and pelargonic acid.

8. The coating of claim 1, wherein the macromolecular compound is poly(dimethylsiloxane) or poly(ethylene glycol).

9. The coating of claim 1, wherein:
m is an integer within a range of between about 30 and about 7,600;
n is an integer;
o is an integer;
the sum of n and o is within a range of between about 30 and about 7,600; and
the sum of m, n and o is within a range of between about 700 and about 7,600.

10. The coating of claim 9, wherein a ratio between n and o is between about 1:19 and about 1:3.

11. The coating of claim 1, wherein the coating contains a drug.

12. The coating of claim 11, wherein the drug comprises actinomycin D, estradiol, paclitaxel, docetaxel, heparin, low molecular weight heparins, heparinoids, heparin derivatives containing hydrophobic counter-ions, rapamycin, derivatives and analogs of rapamycin, clobetasol, or dexamethasone and its derivatives.

13. The coating of claim 1, wherein the medical device is a stent.

14. The coating of claim 1, wherein the polymer absorbs not more than 5% of water by mass.

15. A method for fabricating a polymer coating for a medical device, the method comprising modifying poly(ethylene-co-vinyl alcohol).

16. The method of claim 15, wherein the polymer has a formula: 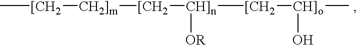
wherein R is selected from a group consisting of a straight chained or branched alkyl radical C₁-C₈, a fully or partially fluorinated alkyl C₁-C₈ sulfonyl group, a fully or partially fluorinated alkyl group C₁-C₈, an acyl group, a secondary amino group, and a substitutent derived from a macromolecular compound.

17. The method of claim 16, wherein modifying is achieved by a method selected from alkylation, fluoroalkylation, silicone addition, esterification, pegylation, introduction of amino groups, and introduction of carboxyl group.

18. The method of claim 17, wherein the esterification is carried by reacting poly(ethylene-co-vinyl alcohol) with an organic acid or a derivative thereof, the acid selected from a group consisting of acetic acid, propionic acid, butyric acid, valeric acid, caproic acid, enanthic acid, caprylic acid, and pelargonic acid.

19. The method of claim 18, wherein the derivative is an acyl or an anhydride.

20. The method of claim 15, wherein the medical device is a stent.

21. A method of coating a medical device, including forming a coating comprising a polymer on the device, wherein the polymer has a formula 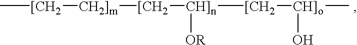
wherein R is selected from a group consisting of a straight chained or branched alkyl radical C₁-C₈, a fully or partially fluorinated alkyl C₁-C₈ sulfonyl group, a fully or partially fluorinated alkyl group C₁-C₈, an acyl group, a secondary amino group, and a substitutent derived from a macromolecular compound.
